(19) United States
(12) Patent Application Publication
(10) Pub. No.: US 2008/0023550 A1
(43) Pub. Date: Jan. 31, 2008

(54) Curved window in electro-optical reader

(76) Inventors: Ming Yu, South Setauket, NY (US); Igor Vinogradov, Bay Shore, NY (US)

Correspondence Address: KIRSCHSTEIN, OTTINGER, ISRAEL;& SCHIFFMILLER, P.C., 489 FIFTH AVENUE, NEW YORK, NY, 10017, US

(21) Appl. No.: 11/496,325

(22) Filed: Jul. 31, 2006

(51) Int. Cl. G06K 7/10

(52) U.S. Cl. 235/462.32

(57) ABSTRACT

A light-transmissive window on a housing of an electro-optical reader is curved to reflect reflections of an outgoing scanning light beam incident on the curved window away from a photodetector in the housing. The curved window minimizes the space between itself and a light assembly in the housing.

### DESCRIPTION OF THE RELATED ART

Electro-optical readers have found wide acceptance in retail, wholesale industrial and military applications. A moving beam reader typically includes a laser/optical assembly for optically modifying and directing a laser beam along an outgoing path to a symbol having regions of different light reflectivity, a scan component for scanning the laser beam across the symbol, a photodetector for sensing return light of variable intensity scattered from the symbol and returning along a return path and for generating an electrical signal indicative of the detected light intensity of the return light, and a signal processing circuit including a digitizer, a decoder, and a microprocessor for processing the electrical signal and for determining widths of and spacings between bars and spaces of the symbol to derive information encoded in the symbol.

The reader includes a housing having a window through which the outgoing light passes in one direction through to the symbol, and through which the return light passes in an opposite direction to the photodetector. The window prevents dust; dirt, moisture and like contaminants from entering the reader from the environment.

It was known in the prior art to make the window of a planar sheet of light-transmissive material, and to position the window in a vertical plane generally orthogonal to the outgoing path of the scanning laser beam. However, a portion of the outgoing horizontal scanning laser beam incident on the vertical window would reflect back inwardly away from the window. Such back-reflections could be sensed by the photodetector and combine with the return light sensed by the photodetector and thus interfere with the signal processing and reading of the symbol.

It was also known to tilt the planar window to avoid the back-reflections. The planar window is tilted sufficiently so that any reflections of the light incident on the window will be directed away from the photodetector. However, the tilted window occupies a relatively large amount of space between the tilted window and the laser/optical assembly. This can be a problem in space-constrained applications.

### SUMMARY OF THE INVENTION

One feature of the present invention resides, briefly stated, in an electro-optical reader for, and a method of, reading indicia, such as bar code symbols. The reader includes a housing, a light assembly in the housing for generating and directing a light beam to the indicia for reflection therefrom, a scan component in the housing for scanning the light beam across the indicia, a photodetector in the housing for detecting return light of variable intensity reflected off the indicia being scanned by the light beam, and a light-transmissive window on the housing and through which the light beam and the return light pass in mutually opposite directions.

In accordance with this invention, the window is curved, preferably cylindrically curved, to reflect any reflections of the light beam incident thereon away from the photodetector. The curved window has a concave surface facing the light assembly and occupies a relatively small amount of space between the curved window and the light assembly. In the preferred embodiment, the window is made of plastic or glass and has no optical power. The curved window is particularly useful in space-constrained applications.

The housing may have a handle for handheld operation, and an elongated body having a front end portion aimed at the indicia. Preferably, the curved window of the handheld reader is mounted at the front end portion.

The novel features which are considered as characteristic of the invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a diagrammatic view of an electro-optical handheld reader with a vertical planar window in accordance with the prior art;

FIG. 2 is a schematic view of a scan engine of a reader with a tilted planar window in accordance with the prior art; and

FIG. 3 is a view of analogous to FIG. 2 but with a curved window in accordance with the invention.

### DETAILED DESCRIPTION OF THE PREFERRED EMBODIMENTS

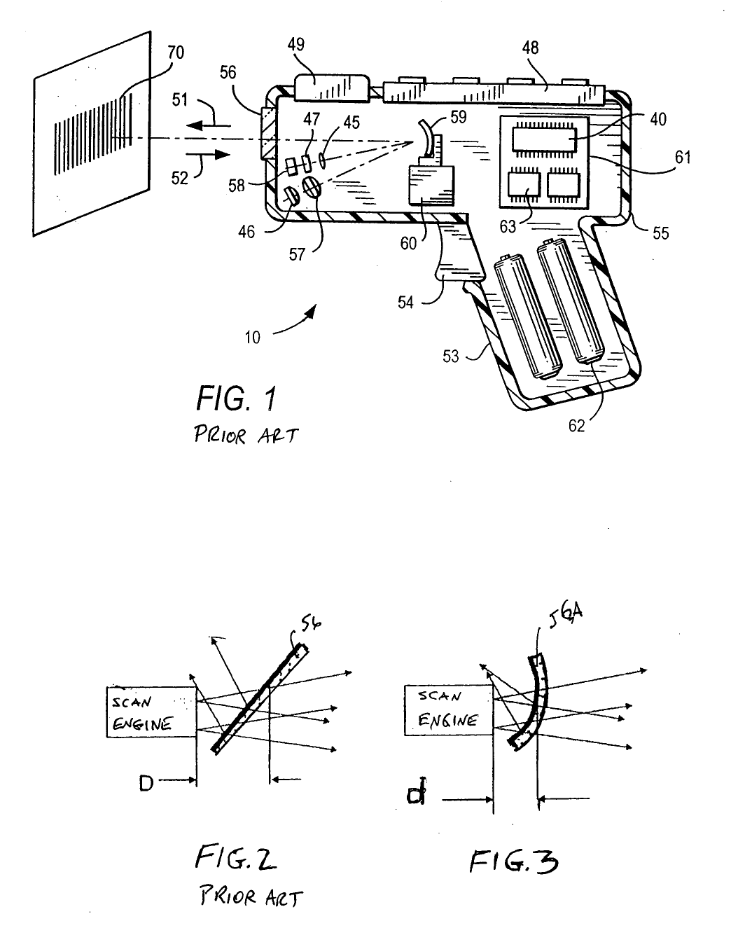

Referring now to the drawings, reference numeral 10 in FIG. 1 generally identifies a portable handheld reader for electro-optically reading indicia such as bar code symbols. The reader 10is preferably implemented as a gun shaped device, having a pistol-grip handle 53. A lightweight plastic housing 55 contains a light source 46, a detector 58, optics 57, signal processing circuitry 63, a programmed microprocessor 40, and a power source or battery pack 62. A planar exit window 56 at a front end of the housing 55 allows an outgoing light beam 51 to exit and incoming reflected return light 52 to enter. An operator aims the reader at a bar code symbol 70 from a position in which the reader 10 is spaced from the symbol, i.e., not touching the symbol or moving across the symbol.

The optics 57 may include a suitable lens (or multiple lens system) to focus the light beam 51 into a scanning spot at an appropriate reference plane. The light source 46, such as a semiconductor laser diode, introduces a light beam into an optical axis of the lens 57, and other lenses or beam shaping structures as needed. The beam is reflected from an oscillating mirror 59 that is coupled to a scanning drive motor 60 energized when a trigger 54 is manually pulled. The oscillation of the mirror 59 causes the outgoing beam 51 to scan back and forth in a desired pattern, such as a scan line or a raster pattern of scan lines, across the symbol.

The return light 52 reflected or scattered back by the symbol 70 passes back through the window 56 for transmission to the detector 58. In the exemplary reader shown in FIG. 1, the return light reflects off the mirror 59, passes through an optical bandpass filter 47 and impinges on the light sensitive detector 58. The filter 47 is designed to have a bandpass characteristic in order to pass the reflected (return) laser light and block the light coming from other optical sources. The detector 58 produces an analog signal proportional to the intensity of the reflected return light 52.

The signal processing circuitry includes a digitizer 63 mounted on a printed circuit board 61. The digitizer processes the analog signal from detector 58 to produce a pulse signal where the widths and spacings between the pulses correspond to the widths of the bars and the spacings between the bars of the symbol. The digitizer serves as an edge detector or wave shaper circuit, and a threshold value set by the digitizer determines what points of the analog signal represent bar edges. The pulse signal from the digitizer 63 is applied to a decoder, typically incorporated in the programmed microprocessor 40 which will also have associated program memory and random access data memory. The microprocessor decoder 40 first determines the pulse widths and spacings of the signal from the digitizer. The decoder then analyzes the widths and spacings to find and decode a legitimate bar code message. This includes analysis to recognize legitimate characters and sequences, as defined by the appropriate code standard. This may also include an initial recognition of the particular standard to which the scanned symbol conforms. This recognition of the standard is typically referred to as autodiscrimination.

To scan the symbol 70, the operator aims the bar code reader 10 and operates the movable trigger switch 54 to activate the light source 46, the scanning motor 60 and the signal processing circuitry. If the scanning light beam 51 is visible, the operator can see a scan pattern on the surface on which the symbol appears and adjust aiming of the reader 10 accordingly. If the light beam 51 produced by the source 46 is marginally visible, an aiming light may be included. The aiming light, if needed, produces a visible light spot that may be fixed, or scanned just like the laser beam 51. The operator employs this visible light to aim the reader at the symbol before pulling the trigger.

As shown in FIG. 1, it was known to position the window 56 in a vertical plane generally orthogonal to the outgoing horizontal path of the outgoing scanning laser beam 51. During reading, a portion of the outgoing horizontal scanning laser beam 51 incident on the vertical window 56 would reflect back inwardly away from the window 56. Such back-reflections would be reflected by the mirror 59 to the detector 58 and would be sensed by the detector 58 and combined with the return light sensed by the detector and thus interfere with the signal processing and reading of the symbol.

To avoid the back-reflections, it was also known to sufficiently tilt the planar window 56, as shown in FIG. 2, so that any reflections of the scanning light beam 51 incident on the window 56 will be directed away from the detector 58. To simplify the drawings, the components 45-47 and 57-60 have been represented in FIG. 2 by a block labeled “scan engine”, which is a term generally used in the art to collectively describe these components. However, the tilted window 56 occupies a relatively large amount of space “D” between the tilted window 56 and the laser/optical assembly in the scan engine. This is a problem in space-constrained applications.

In accordance with this invention, as shown in FIG. 3, the window is curved, preferably cylindrically curved, to reflect any reflections of the scanning light beam 51 incident thereon away from the detector 58. The curved window 56A has a concave surface facing the light assembly in the scan engine and occupies a relatively small amount of space “d” between the curved window 56A and the light assembly. In the preferred embodiment, the curved window 56A is made of plastic or glass and has no optical power. The curved window 56A is particularly useful in space-constrained applications.

It will be understood that each of the elements described above, or two or more together, also may find a useful application in other types of constructions differing from the types described above.

While the invention has been illustrated and described as embodied in a curved window in an electro-optical reader, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention and, therefore. Such adaptations should and are intended to be comprehended within the meaning and range of equivalence of the following claims.

We claim:

1. An electro-optical reader for reading indicia, comprising:
a) a housing;
b) a light assembly in the housing for generating and directing a light beam to the indicia for reflection therefrom;
c) a scan component in the housing for scanning the light beam across the indicia;
d) a photodetector in the housing for detecting return light of variable intensity reflected off the indicia being scanned by the light beam; and
e) a light-transmissive window on the housing and through which the light beam and the return light pass in mutually opposite directions, the window being curved to reflect reflections of the light beam incident thereon away from the photodetector.

2. The reader of claim 1, wherein the window is cylindrically curved.

3. The reader of claim 1, wherein the window is made of plastic.

4. The reader of claim 1, wherein the window is made of glass.

5. The reader of claim 1, wherein the housing has a handle for handheld operation.

6. The reader of claim 1, wherein the housing has an elongated body having a front end portion aimed at the indicia, and wherein the window is mounted at the front end portion.

7. The reader of claim 1, wherein the window has a concave surface facing the light assembly.

8. A method of reading indicia, comprising the steps of:
a) generating and directing a light beam along an outgoing path to the indicia for reflection therefrom;
b) scanning the light beam across the indicia:
c) detecting return light of variable intensity reflected off the indicia being scanned by the light beam along a return path by employing a photodetector; and
d) positioning a light-transmissive window in the paths of the light beam and the return light, and curving the window to reflect reflections of the light beam incident thereon away from the photodetector.

9. The method of claim 8, wherein the curving step is performed by forming the window with a cylindrically curved shape.

10. The method of claim 8, and constituting the window of plastic.

11. The method of claim 8, and constituting the window of glass.

12. The method of claim 8, wherein the positioning step is performed by mounting the window on a housing, and configuring the housing with a handle for handheld operation.

13. The method of claim 12, and configuring the housing with an elongated body having a front end portion aimed at the indicia, and wherein the positioning step is performed by mounting the window at the front end portion.

14. The method of claim 8, wherein the curving step is performed by forming the window with a concave surface facing the light beam.

15. An electro-optical reader for reading indicia, comprising:
a) housing means;
b) light assembly means in the housing means for generating and directing a light beam to the indicia for reflection therefrom;
c) scan component means in the housing means for scanning the light beam across the indicia;
d) photodetector means in the housing means for detecting return light of variable intensity reflected off the indicia being scanned by the light beam; and
e) light-transmissive window means on the housing means and through which the light beam and the return light pass in mutually opposite directions, the window means being curved to reflect reflections of the light beam incident thereon away from the photodetector means

16. The reader of claim 15, wherein the window means is cylindrically curved.

17. The reader of claim 15, wherein the window means is made of plastic.

18. The reader of claim 15, wherein the window means is made of glass.

19. The reader of claim 15, wherein the window means has a concave surface facing the light assembly means.

20. The reader of claim 15, wherein the housing means has an elongated body having a front end portion aimed at the indicia, and wherein the window means is mounted at the front end portion.
